(19) United States
(12) Patent Application Publication
(10) Pub. No.: US 2012/0046866 A1
(43) Pub. Date: Feb. 23, 2012

(54) OILFIELD APPLICATIONS FOR DISTRIBUTED VIBRATION SENSING TECHNOLOGY

(75) Inventors: JOERG H. MEYER, Houston, TX (US); Michael Carney, Houston, TX (US); Bobby D. Poe, Houston, TX (US)

(73) Assignee: SCHLUMBERGER TECHNOLOGY CORPORATION, Sugar Land, TX (US)

(21) Appl. No.: 13/215,922

(22) Filed: Aug. 23, 2011

Related U.S. Application Data
(60) Provisional application No. 61/376,104, filed on Aug. 23, 2010.

(51) Int. Cl. G01V 1/42; G06F 19/00

(52) U.S. Cl. 702/6

(57) ABSTRACT

Methods and apparatus for monitoring a hydrocarbon production system. A fiber optic sensor system is deployed into hydrocarbon production system, so as to extend to location of interest within the system, for instance, in conjunction with a downhole component or a surface component. The fiber optic system detects vibration present in the production system component, and provides a signal indicative of the vibration to a signal acquisition and analysis unit. The vibration of the production component is analyzed and a change in system flow condition/property or a change in production system component integrity is determined.

### CROSS-REFERENCE TO RELATED APPLICATIONS

This application claims the benefit of U.S. Provisional Application Ser. No. 61/376,104 entitled “OILFIELD APPLICATIONS FOR DISTRIBUTED VIBRATION SENSING TECHNOLOGY” filed Aug. 23, 2010, which is incorporated by reference herein.

### BACKGROUND

Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed in order to control and enhance the efficiency of producing the various fluids from the reservoir.

The analysis, evaluation, characterization, and monitoring of fluid flow and injection from and into wells and through associated pipelines is a constant need in the life of a hydrocarbon producing asset. The understanding of what fluid is moving where in a flow conduit whether it is the well, subsea riser or the associated surface facilities and pipelines is one of the most fundamental needs of the oil and gas industry.

This is needed for understanding and optimally producing a reservoir to achieve the greatest economic benefit. During the life of a hydrocarbon producing asset, one of the biggest objectives is to efficiently drain the reservoir to maximize hydrocarbon recovery. Understanding what fluid or gas is being produced from what zone is essential to this understanding.

Additionally, it is necessary for the safety and environmental needs during production and injection. The production of hydrocarbons can be a hazard not only to the people working in proximity to the operations but to the environment as well. The understandings of what fluids are moving and where gives an understanding of the operating conditions leading to safe operations. Accordingly, there exists a need for methods and apparatus to monitor fluids associated with hydrocarbon production.

Various types of equipment can be deployed in a wellbore and other parts of a production system e.g. tubulars, subsea risers, to perform desired tasks, including well logging, fluid production, fluid injection, and other tasks. Examples of equipment include tubing, pipes, valves, motors, pumps, and so forth. All equipment placed in or as part of a production or injection system is subject to wear, erosion, corrosion, or some form of physical degradation over time.

In the relatively harsh environments that are typically present in wellbores, equipment positioned in the wellbore may wear out or fail. When equipment fails or exhibits reduced performance, an expensive intervention operation typically has to be performed, in which the failed equipment is extracted from the wellbore, and either repaired or replaced. Having to extract well equipment from a wellbore means that the wellbore may have to be shut in while the repair or replacement process proceeds. Shutting in a wellbore may cause deferred production, fluid production or injection operations to stop or reduced overall recovery factor, which can result in revenue loss. Also, having to perform an intervention operation means that service personnel have to be sent out to the well site, which can also be costly.

Therefore, there is a need to monitor equipment integrity. Different environments and different operating conditions will case different types of wear. Using vibration and noise as a tool to monitor equipment offers many opportunities to detect and diagnose potential problems before they occur.

### SUMMARY OF THE INVENTION

As stated above, the understanding of fluid flow is critical to operational efficiency in the oil and gas industry. A significant amount of time and effort is dedicated to understanding what fluid or gas is flowing from which zones within a well. Additionally, the understanding of fluid flow is critical throughout the hydrocarbon production system including related surface facilities. The same holds true for fluids and gases which are injected into subsurface reservoirs for the purpose of maintaining and increasing reservoir productivity. It is just as critical to understand the flow of these fluids in the surface pipeline network and subsurface.

Distributed vibration measurements using fiber optic technology whereby the fiber is installed in or near the production system, whether in the surface facilities of in down-hole conditions, offers the opportunity to effectively monitor fluid movement and make a determination of the fluid velocity. Vibration, either naturally occurring or induced through mechanical means, offers the ability to characterize fluid flow qualitatively and quantitatively depending on the fluid type and fluid properties. This invention is a description of the uses of vibration in a production/injection system to determine fluid flow and location within the system.

Additionally, the understanding of equipment integrity is critical to operational efficiency in the oil and gas industry. A significant amount of time and effort is dedicated to monitoring and maintaining production equipment within a well and in the production and injection systems.

Distributed vibration measurements using fiber optic technology whereby the fiber is installed in or near the production system, whether in the surface facilities of in down-hole conditions, offers the opportunity to effectively monitor equipment integrity and make a determination of when action needs to be taken to make changes to operations or if necessary make repairs. Vibration, either naturally occurring or induced through mechanical means, offers the ability to characterize equipment integrity qualitatively and quantitatively depending on the nature and understanding of the noise and vibration in the system. This invention is a description of the uses of vibration in a production/injection system to determine equipment integrity within the system.

### BRIEF DESCRIPTION OF THE DRAWINGS

Certain embodiments of the invention will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current invention.

FIG. 1 illustrates an exemplary embodiment wherein a fiber optic cable is deployed into a wellbore for monitoring fluid flow through the wellbore;

FIG. 2 illustrates an exemplary embodiment wherein a fiber optic cable is deployed into a wellbore for monitoring downhole equipment deployed in the wellbore;

FIG. 3 illustrates an exemplary embodiment wherein a fiber optic cable is deployed into a wellbore with a gravel pack and screen for monitoring the gravel pack process and subsequent flow;

FIG. 4 illustrates an exemplary embodiment wherein a fiber optic cable is deployed into a wellbore that is completed with downhole control valves;

FIG. 5 is a schematic representation of indicators over time to indicate changes in downhole conditions as monitored from a fiber optic sensor;

FIG. 6 is a schematic diagram of an optical fiber mechanism used to observe downhole conditions, as according to one embodiment; and

FIG. 7 is a schematic diagram of an exemplary system to process data received from a downhole fiber optic monitoring system, according to an embodiment.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention. As used herein: the abbreviation “FCV” is understood to mean “flow control valve”; the abbreviation “ICV” is understood to mean “inflow/outflow control valve”; the abbreviation “ICD” is understood to mean “inflow/outflow control device”; the abbreviation “DVS” is understood to mean “distributed vibration sensing”; and the abbreviation “ESP” is understood to mean “electric submersible pump”.

Some implementations of various technologies described herein generally relate to methods and tools for evaluating fluid flow and status in a wellbore and or production pipelines and surface facilities related to utilizing Distributed Vibration Sensing (DVS) either as a standalone sensor or in combination with other sensors.

In some embodiments, information regarding fluid flow or component integrity or component operating condition may be determined for any point in a hydrocarbon production system. A hydrocarbon production system may include components which are disposed at locations downhole, or in the wellbore, and components which are located at or near a wellhead surface facility. A non-exhaustive list of components located at or near a wellhead surface facility includes: christmas trees; surface chokes; flowlines; separators; heaters; treaters; and meter runs.

From a production or operations applications perspective, Distributed Vibration Sensing (DVS) represents a technology that can provide useful information related to fluid flow in a surface and downhole production and or injection system. Such flow system can contain solids. A production system may contain technologies and equipment for fluid production and/or injection. The lack or disruption of flow of production or injection fluids or an intervention before such disruption can be one of the outcomes of such flow characterization.

Understanding the flow of production and injection fluids at various locations of a production system (topside, downhole, at (in) the completion, either inside or outside the sand screen, outside of casing, between the tubing and casing, etc.) is fundamental and impacts the overall efficiency, effectiveness, and consequently the NPV of all production operations. Examples are, but are not limited to, information of the related flow regime (laminar, stratified, turbulent, etc.), production or injection rate, fluid properties (viscosity, density), fluid conduit cross section area (e.g. reduction by deposits), as well as changes of these and other parameters. One advantage of using continuous monitoring such as DVS is that remedial action may be required only on the basis of exception handling.

Some implementations of various technologies described herein generally relate to methods and tools for evaluating integrity of equipment in a wellbore and production pipelines related to utilizing Distributed Vibration Sensing (DVS) either as a standalone sensor or in combination with other sensors.

In general, an optical fiber mechanism is provided to monitor equipment positioned in a wellbore. Using information detected or measured by the optical fiber mechanism that is responsive to vibration or other changes of mechanical forces resulting in vibration associated with the equipment, a status of the equipment can be detected.

From a production applications perspective, Distributed Vibration Sensing (DVS) represents a technology that can provide useful information related to monitoring of the integrity or operating conditions of equipment and technologies of a surface and downhole production and or injection system. A production system may contain technologies and equipment for fluid production and/or injection. The identification, assessment, and characterization of the equipment both above and below the wellhead and in downhole conditions are the result of such integrity monitoring. This can include, but is not limited to uptime monitoring; proper functioning or abnormal operating conditions of production and or injection system equipment and components; monitoring for leaks and or equipment failures; production of sands, silts, and solids; deposition of organic or chemical buildup such as wax, asphaltene, or scale; and in general abnormal operating conditions related to physical equipment. The outcome of such integrity monitoring can be, but is not limited to, remedial actions and interventions to optimize the effectiveness of production and injection operations. The main advantage of using continuous monitoring such as DVS is that any intervention and/or remedial action may be required only on the basis of exception handling.

Prompt identification of possible suboptimal operating conditions, performance or malfunctioning of production system equipment is fundamental and impacts the overall efficiency, effectiveness and consequently the NPV of all production operations. Examples are but are not limited to tubing leaks, gas lift valve malfunctioning or issues related to ESP operations. Besides an identification of equipment malfunctioning, a continuous surveillance enables to monitor changes of equipment component conditions and performance.

In some embodiments, an optical fiber mechanism is provided for monitoring downhole equipment positioned in a wellbore. The optical fiber mechanism is used for detecting vibration noise associated with the downhole equipment. For example, equipment with moving parts, such as motors, pumps, valves, and so forth, move and or wear out over time. As such equipment moves and or wears out, vibration noise is generated.

In some embodiments, during fluid production or injection, particles in the fluid may impact walls of conduits in the wellbore and or downhole equipment—such particle impacts may lead to vibration noise that is also detectable by the optical fiber mechanism, such as for the purpose of determining whether fluid flow has stopped which may indicate a problem in the well. The movement of particles and their impact on downhole equipment can have an adverse effect on the operational capabilities of the equipment. Vibration of equipment, noise caused by particles impinging on equipment, or any other noise that may be induced downhole, is considered an “acoustic event.”

In some embodiments, vibration signature analysis can be performed based on data collected by the optical fiber mechanism that is affected by acoustic events related to downhole equipment. The vibration signature analysis involves comparing a signature based on data collected from the optical fiber mechanism with a predefined signature, and providing a result based on the comparing. For example, wear may be detected based on the comparing that the detected vibration exceeds one or more predefined vibration limits.

In some embodiments, a coherent light source (e.g., a laser source) that produces coherent light can be used to generate optical pulses (also referred to as “probe” optical pulses) that are transmitted into an optical fiber. In response to one or more probe optical pulses transmitted into the optical fiber, backscattered light is returned to the location of the source. A detector can be positioned near the source to receive the backscattered light. Vibration noise that is present in a location downhole in the wellbore will cause a portion of the optical fiber to be subjected to acoustic waves, which can cause a localized change in the refractive index of the portion of the optical fiber. This change in the characteristic of the optical fiber portion will cause a change in the characteristic of the backscattered light received at the detector.

In some embodiments, an optical fiber mechanism may include an optical fiber that is connected to at least one or more single-component or multi-component (2C or 3C) vibration sensor system. The single-component or multi-component (2C or 3C) vibration sensor system sensor, which may be a hydrophone, accelerometer, or other device that is able to detect acoustic waves or particle motion, is operatively connected to the optical fiber. The single-component or multi-component (2C or 3C) vibration sensor system sensor is sensitive to acoustic waves that may be caused by vibration noise associated with the downhole equipment. The single-component or multi-component (2C or 3C) vibration sensor system sensor enhances the sensitivity of the optical fiber locally to an acoustic wave, which may be a pressure wave (a scalar quantity detectable with a hydrophone, for example) or particle motion (which can be detected with a sensor designed to measure acceleration).

In some embodiments, one way of converting acoustic waves to an optical signal is through interferometric sensors, which convert a pressure wave or an acceleration into a path-like change (e.g., by straining the optical fiber) and thus modulating the phase of light traveling through the portion of the optical fiber that is affected by the seismic sensor. One exemplary implementation involves winding a section of an optical fiber on a compliant cylinder (which may be part of a hydrophone, for example), which varies the strain on the optical fiber in response to a pressure wave. An accelerometer-based design can include mass-loaded compliant materials (e.g., rubber) and flexural disks, which convert acceleration to strain on the optical fiber portion that is attached to the accelerometer.

Backscattered light received at the detector in any embodiment discussed above may be analyzed by an analysis unit for determining what the equipment noise level is, and whether the equipment noise level is within acceptable limits. In one example implementation, analysis of the light information received by the detector may involve first converting the incoming time series of light signals to the frequency domain, and then using spectral analysis techniques to determine a departure from the expected acoustic signature. In other implementations, time domain pattern-matching, or wavelet transform comparisons, can be used to determine whether the detected light corresponds to a noise level that is outside acceptable limits.

In accordance with some embodiments, an optical fiber mechanism is provided for monitoring downhole fluid flow in a wellbore. The optical fiber mechanism is used for detecting vibration (e.g. vibration noise) associated with the flow, or with the downhole equipment. For example, as the fluid flows, irregularities in the flow path or changes in the flow conduit may cause vibration increases or decreases with corresponding changes in fluid velocity and direction. As another example, equipment with moving parts, such as motors, pumps, valves, etc, move and or wear out over time. The movement or wear of such equipment may generate vibration noise which may be detectable by the optical fiber mechanism. The movement of particles and their impacts on downhole equipment can have an adverse effect on the operational capability of the equipment, and therefore, being aware of these impacts may allow an indication of equipment condition and life. As another example, during fluid production or injection, particles in the fluid may impact walls of conduits in the wellbore or downhole equipment—such particle impacts may lead to vibration noise that is also detectable by the optical fiber mechanism, such as for the purpose of determining whether fluid flow has stopped which may indicate a problem in the well. Such Vibration noise of equipment, noise caused by particles impinging on equipment or the flow tube, or any other noise induced or observed down hole may be considered an “acoustic event”.

In some embodiments, an optical fiber may be deployed along with the addition of specific down-hole tool that causes a change in the flow regime which in turn causes a vibration that then may be detected by the fiber. As another example, the down-hole tool may be designed to vibrate, either in the flow stream of as a direct result of the fluid flow which is then evaluated to determine flow rate and or changes thereof.

In some embodiments, a common occurrence associated with hydrocarbon liquid production is the production of fines which include but are not limited to particles of sand, sediment, and precipitated solids. The vibrations resulting from the impacting of the particles may give an indication of the flow rate. Another result is that the noise associated with the particles may give indications of the volume of particles being produced. An additional indication from the vibration analysis may be the size of the particles. In any of these cases, understanding the source, velocity, and nature of the particles is useful to understand the well's producing condition.

In some embodiments, the well may be a producer of free gas in addition or association with the production of liquids. The production of gas may be a source of a characteristic vibration/noise signature which would yield useful information about the velocity, location and volume of gas being produced. Another example of this may be when gas suddenly begins being produced in what is normally considered an oil producing well. This may result from gas breaking through the formation or as a result of coning. This may be an undesirable condition and understanding where the gas is coming from and the rate is valuable information that can be resolved using noise and vibration analysis.

In some embodiments, gas may be used for injection for the purpose of assisting in lifting fluid in the well. This is commonly referred to as gas lift, or artificial lift. The nature of the gas lift process requires that the gas be injected into the flow stream at one or more levels in the well. It may be interesting to know where the gas is being injected so that the pressure and rate can be controlled to optimally yield the greatest flow rate. As the gas is released into the flow stream, the resulting vibration/noise signature may yield information about this optimization process.

In some embodiments, reservoirs which produce gas may also produce some liquid (typically water, but any other liquid is possible) that may result in the reduction and eventual stoppage of gas production. This liquid may need to be removed before the well can be placed back on production. Knowing when the fluid is being produced and how much is standing in the well bore is useful for planning field work (e.g. removal of the fluid). As the gas flows through the liquid, the release of acoustic energy associated with gas bubbling through the liquid may give an indication of the fluid level within the well. This may then allow for the estimation of pressure at the producing zone and an understanding of when the pressure will be sufficient to stop gas production. Using this characteristics of the vibration/noise to evaluate the fluid level may be useful in planning field operations.

In some embodiments, the completion of a well may be controlled through the use of both passive and active downhole valves. The understanding of how much fluid is being produced in each zone and valve can yield information for controlling the well and optimizing its production. The use of acoustic signature and its analysis can prove useful in this way for ensuring production optimization through the completion.

In some embodiments, the completion of the well may be such that the seal between strings of pipe or between the casing and the rock may be insufficient to restrict fluid flow during either production or injection. This may cause environmental and mechanical issues in the wellbore, and the detection of these as soon as possible may be important. The flow of fluid or gas behind pipe or in the space between pipes can generate vibrations and noise which may have specific signatures giving an indication of how much fluid or gas is moving and where it is located. This may be detected and analyzed through the use of distributed vibration sensing.

In some embodiments, fluid may be injected in a well as a treatment or stimulation. Analysis of the signature of the vibration as the fluid is injected can give an indication of where the fluid is going, resulting in an understanding of the quality of the treatment and as a source for modifying or optimizing the treatment.

In some embodiments, a well may be completed with what is commonly referred to as a gravel pack where sand and gravel is placed in the zone of completion to limit the well from producing sand and fines from the reservoir. Proper gravel packing through the placement of the sand and gravel contributes to the success of controlling sand and fine production. Utilization of distributed vibration sensing and analysis during the completion procedure for the placement of the sand and gravel in the well may help insure the productive life of the well.

In some embodiments, the flow of the fluid, after leaving the well, flows into a production system of pipes and flowline leading to treatment and storage facilities. It may be useful to understand the flow within this network of pipes where conditions may change resulting in precipitation and deposition of solids restricting flow and resulting in fluid flow problems. These may be monitored using optical distributed vibration measurement and analysis techniques to understand changes over time in the flow regime within the pipe network. The analysis of this may yield information about changes in the flow regime as they happen and allow for remedial action to be taken prior to problems occurring (e.g. leaks, blockages, stoppages, etc).

In some embodiments, vibration signature analysis may be performed based on data collected by the optical fiber mechanism that is affected by acoustic events related to downhole fluid flow. The vibration signature analysis involves comparing a signature based on data collected from the optical fiber mechanism with a predefined signature, and providing a result based on the comparison. For example, wear may be detected based on comparing or determining if the detected vibration exceeds on or more predefined vibration limits.

In some embodiments, a coherent light source (e.g., a laser source) that produces coherent light can be used to generate optical pulses (also referred to as “probe” optical pulses) that are transmitted into an optical fiber. In response to one or more probe optical pulses transmitted into the optical fiber, backscattered light is returned to the location of the source. A detector may be positioned near the source to receive the backscattered light. Vibration noise that is present in a location downhole in the wellbore may cause a portion of the optical fiber to be subjected to acoustic waves, which may cause a localized change in the refractive index of the portion of the optical fiber. This change in the characteristic of the optical fiber portion may cause a change in the characteristic of the backscattered light received at the detector.

In some embodiments, backscattered light received at the detector discussed above may be analyzed by an analysis unit for determining what the flow rate noise level is, and whether the flow rate noise level is within acceptable limits. In one example implementation, analysis of the light information received by the detector may involve first converting the incoming time series of light signals to the frequency domain, and then using spectral analysis techniques to examine the acoustic signature to determine flow rate. In other implementations, time domain pattern-matching, or wavelet transform comparisons, may be used to determine whether the detected light corresponds to a noise level associated with expected flow rates.

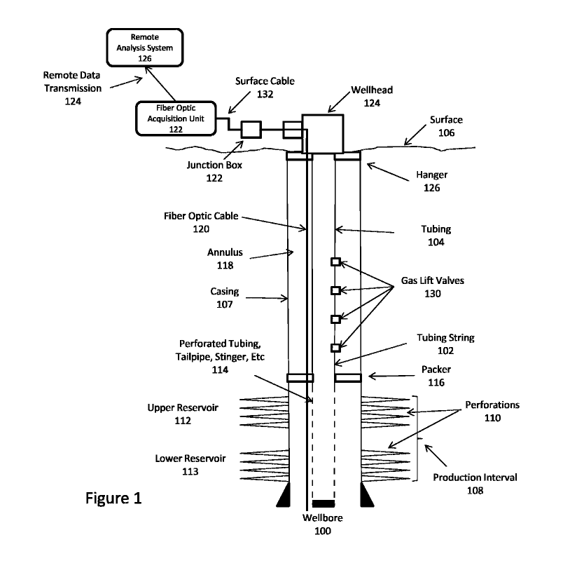

Referring generally to FIG. 1, an embodiment of system to monitor fluid flow in a wellbore 100 is illustrated. In this embodiment, perforations 110 are formed into the upper reservoir 112 and lower reservoir 113 to enable fluids from the upper reservoir 112 and lower reservoir 113 to flow into the wellbore 100 for production through the tubing 104.

Also illustrated in the embodiment of FIG. 1 is an optical fiber (in the form of a fiber optic cable) 120 that extends along a length of the tubing string 102. In the arrangement of FIG. 1, the fiber optic cable 120 runs along the outside of the tubing string 104.

Although the fiber optic cable 120 is depicted as outside of tubing string 104, the location of the fiber optic cable 120 should not be limited to the embodiment shown. It should be noted that the fiber optic cable 120 can be outside of the casing 107, inside of the tubing 104, or even in an offset well (not shown in this diagram), among other locations.

The fiber optic cable 120 may be one of several different types of fiber optic cables, such as: (1) a permanent fiber optic cable that is laid into the cable during manufacturing; (2) a fiber optic cable that is pumped into a control line that is provided in the wellbore 100; (3) a bare optical fiber that is run from the earth surface to the area of interest downhole, or (4) a fiber that is part of a episodic log run as part of normal wireline, slickline, or within coiled tubing.

During production or injection, fluid flow may be associated with a certain amount of vibration. Vibration noise created by production or injection can be detected as acoustic waves (pressure waves) or as particle motion.

In these embodiments, the acoustic waves that impinge upon a fiber optic cable 120 in the area of the perforations 110 may cause a characteristic of the fiber optic cable to change, which affects characteristics of backscattered light from the fiber optic cable portion in the area of the perforations 110. A portion of the fiber optic cable 120 in the proximity of the perforations 110 means that the portion of the fiber optic cable 120 is capable of detecting vibration noise associated with the flow to or from the perforations 110.

In some embodiments, a fiber optic acquisition unit 122 may be positioned at the earth surface 106 close to the wellbore 100. The fiber optic cable 120 extends from the fiber optic acquisition unit 122 through the hangar 126 into the wellbore 100. The fiber optic acquisition unit 122 includes a light source for producing optical signals that are transmitted into the fiber optic cable 120. Backscattered light is received by a detector in the fiber optic acquisition unit 122.

In the illustrative embodiment of FIG. 1, the signals detected by the detector of the fiber optic acquisition unit 122 are transformed into data that can be transmitted (at 124) to a remote analysis unit 126. The analysis unit 126 may be used to analyze the data corresponding to the detected signals to determine whether any problem is present in the wellbore 100. In some embodiments, the data may be acquired by the fiber optic acquisition unit 122 in real time, and that the analysis unit 126 can analyze such data in real time in order to provide instantaneous (or nearly instantaneous) status updates of downhole conditions or conditions of a downhole component. In some embodiments, any background noise may be initially detected (such as by monitoring backscattered signals from the fiber optic cable 120 before any downhole operation is started). This background noise may then be removed from subsequent data considered by the analysis unit 126 for more accurate processing.

In some embodiments, instead of using a remote analysis unit 126, the analysis unit 126 may be part of the fiber optic acquisition unit 122.

As show in FIG. 1, in some embodiments, the downhole equipment includes a tubing string 102 that has a tubing 104 that extends below the packer 116 to a production interval 108, which includes perforations 110 that extend into the upper reservoir 112 and lower reservoir 113. The tubing 104 that is proximate the production interval 108 includes a perforated tubing section 114 that has perforations to enable fluids to flow into the inner bore of the tubing 104.

As show in FIG. 1, and in some embodiments the tubing 104 that is proximate the production interval 108 may include tailpipe, a stinger, sand screen, gravel pack completion, or some other conveyance (not depicted in this diagram) that enables the conveyance of the fiber optic cable 120 to a depth in the wellbore 100 below the level of the production interval 108 to allow to enable the monitoring of fluids produce from or injected into the production interval 108.

Also depicted in FIG. 1 is a packer 116 that is set to isolate the production interval 108 from an annulus 118 above the packer 116.

A fiber optic cable 120 extends from a junction box 122 at the earth surface 106, through wellhead equipment 124, through a hanger 126 (on which the tubing string 102 is supported), and along the length of the tubing string 102. The fiber optic cable 120 also extends through the packer 116 to the production interval 108. The junction box 122 is connected by a surface cable 132 to a fiber optic acquisition unit 122.

Although not expressly shown, it is noted that additional sensors may be provided, such as to measure single-point or distributed temperature measurements or pressure measurements, among other sensors.

Although not expressly shown, in some embodiments, one or more other sensors, such as to measure single-point or distributed temperature measurements or pressure measurements, multi-axis acoustic sensors, or other sensors, may be connection to or run in association with the fiber optic cable 120 anywhere along its entire length from the hanger 126 to the end if the fiber optic cable 120 below the production interval 108.

In the production interval 108, vibration noise can be caused by sand particles or other particles hitting the tubing 104 as a result of fluid flow. The acoustic waves caused by the sand particles hitting the tubing wall can be used to help identify which zone (e.g., perofrations 110 in proximity of the upper reservoir 112) is producing sand or other particles, and if the volume of the sand or other particles is such that damage will occur unless some remedial action is taken. In this example the vibration detected from flow from the upper reservoir 112 is different and distinguishable from flow from the lower reservoir.

Likewise, other changes in the acoustic signature of the production interval 108 can occur if the perforations 110 become obstructed, or if the well becomes distorted through geological movement (e.g., formation compaction), or the dimensions of the wellbore 100 change significantly through corrosion or deposition of solids, such as scale, among others. Once a baseline of the noise associated with known actions is established, any deviation from that baseline may signify an event which may provide information as to the operating condition of the well.

In some embodiments, the system depicted in FIG. 1 may be linked to a central control system that may provide alarms to users in response to various conditions associated with the wellbore. For example, the analysis unit 126 may provide the information to the central control system, which in turn may provide alerts or alarms to users. This may allow the system to automatically update monitoring condition limits to be more appropriate to operating conditions, for example. The monitoring condition limits refers to the limits associated with vibrations of downhole components or other acoustic events associated with the downhole components that are compared to by the analysis unit 126 to determine if a problem exists in the wellbore. Effectively, the central control system may provide feedback to the analysis unit 126 to enable the analysis unit 126 to modify the limits.

Also, the central control system may perform automatic control of equipment, whether downhole or at the earth surface, in response to information provided by the analysis unit 126. For example, the central control system may activate or deactivate the equipment, perform incremental adjustment of the equipment, or provide user notification to enable the user to manually adjust the equipment.

In some embodiments, and as shown in FIG. 1, there is the possibility for the well to be produced with the assistance of gas that is injected down the annulus 118 and produced through the gas lift valves 130. The gas that is produced through the gas lift valves 130 is used to lighten the pressure of the hydrostatic column allow hydrocarbon liquids and water to flow more easily up the tubing string 104. The vibrations sensed along the fiber optic cable 120 in the proximity of the gas lift valves 130 can help distinguish which gas lift valve (or valves) 130 are allowing gas to pass through. This will aid in the operational efficiency of the well.

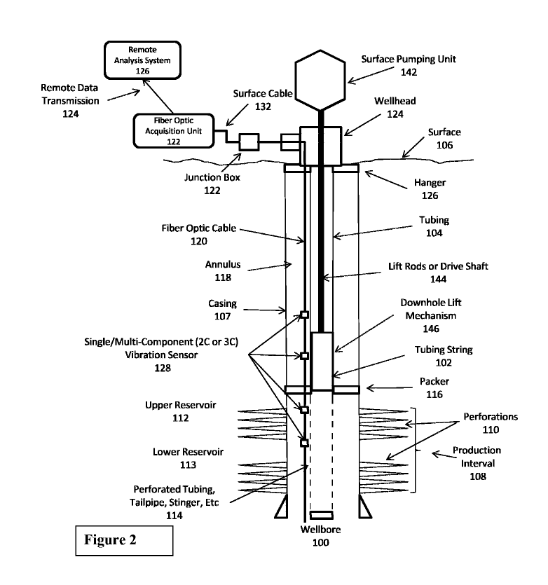

Referring generally to FIG. 2, an embodiment of system to monitor vibration, and downhole equipment in a wellbore 100 is illustrated. In some embodiments, as depicted in FIG. 2, perforations 110 are formed into the upper reservoir 112 and lower reservoir 113 to enable fluids from the upper reservoir 112 and lower reservoir 113 to flow into the wellbore 100 for production through the tubing 104.

Also illustrated in the embodiment of FIG. 2 is an optical fiber (in the form of a fiber optic cable) 120 that extends along a length of the tubing string 102. In the arrangement of FIG. 2, the fiber optic cable 120 runs along the outside of the tubing string 104.

Also illustrated in the embodiment of FIG. 2 are multiple single/multi-component (2C or 3C) vibration sensors 128 attached to the fiber optic cable 120. Although there are several single/multi-component (2C or 3C) vibration sensors 128 depicted in this figure, the fiber optic cable can be installed with any number of single/multi-component (2C or 3C) vibration sensors 128.

Although FIG. 2 is depicted with a fiber optic cable 120 and several single/multi-component (2C or 3C) vibration sensors 128, there is no requirement for to include single/multi-component (2C or 3C) vibration sensors 128. The fiber optic cable 120 may be run as a standalone sensor with no additional sensors.

Although the fiber optic cable 120 and single/multi-component (2C or 3C) vibration sensors 128 are depicted as outside of tubing string 104, the location of the fiber optic cable 120 and single/multi-component (2C or 3C) vibration sensors 128 are not limited to this location. It should be noted that the fiber optic cable 120 and single/multi-component (2C or 3C) vibration sensors 128 can be outside of the casing 107, inside of the tubing 104, or even in an offset well (not shown in this diagram), among other locations.

The fiber optic cable 120 may be one of several different types of fiber optic cables, such as: (1) a permanent fiber optic cable that is laid into the cable during manufacturing; (2) a fiber optic cable that is pumped into a control line that is provided in the wellbore 100; or (3) a bare optical fiber that is run from the earth surface to the area of interest downhole, or (4) a fiber that is part of a episodic log run as part of normal wireline, slickline, or within coiled tubing.

During production, injection, or completion operations, fluid flow as well as associated downhole equipment noise is associated with a certain amount of vibration. Vibration noise created by the movement of fluid during production, injection, or completion operations and by the movement of downhole equipment either as a result of the production, injection, or completion operations or as a result of the movement of the equipment; such as the movement of a valve or rotation of a pump; can be detected by acoustic waves (pressure waves) or as particle motion.

Also illustrated in the embodiment of FIG. 2, is a method of artificial lift whereby a pump is used to lift produced fluids to the surface. In this drawing the method of artificial list is depicted as a surface pump 142 connected to a lift rod or drive shaft 144 which transfers the surface pump 142 energy to a downhole lift mechanism 146.

In some embodiments, the surface pump 142 and the lift rod or drive shaft 144 are replaced with a downhole pump commonly referred to as an electronic submersible pump (ESP) or a hydraulic submersible pump (HSP), not depicted in this diagram. These pumps are usually place in the well in a similar position to the downhole lift mechanism 146 as shown in FIG. 2.

Operation of the surface pump 142, movement and or rotation of the lift rod or drive shaft 144 movement of downhole lift mechanism 146 or rotation of an ESP (not expressly depicted in FIG. 2) is associated with a certain level of vibration. The equipment has moving parts that may wear out over time. As such moving parts wear out, the equipment may cause greater vibration thereby increasing vibration noise.

In some embodiments, vibration noise created by the downhole equipment can be detected as acoustic waves (pressure waves) or as particle motion. In embodiments without the single/multi-component (2C or 3C) vibration sensors 128, the acoustic waves that impinge upon a local portion of the fiber optic cable 120 in the proximity of the downhole equipment may cause a characteristic of the fiber optic cable portion 120 to change, which affects characteristics of backscattered light from the fiber optic cable portion 120. A portion of the fiber optic cable 120 in the proximity of the downhole equipment being monitored means that the portion of the fiber optic cable 120 is capable of detecting vibration noise associated with the downhole equipment being monitored.

In some embodiments where the single/multi-component (2C or 3C) vibration sensors 128 are included, the vibration characteristics from the 2 or 3 axis of motion may be indicative of specific failure modes associated with the downhole equipment being monitored.

In some embodiments, which include single/multi-component (2C or 3C) vibration sensors 128, the single/multi-component (2C or 3C) vibration sensors 128 can cause a strain on the fiber optic cable portion 120 to change in response to the vibration noise. This interaction also effectively causes a change in the backscattered light from the fiber optic cable portion 120.

In some embodiments, a fiber optic acquisition unit 122 may be positioned at the earth surface 106 close to the wellbore 100. The fiber optic cable 120 extends from the fiber optic acquisition unit 122 through the hangar 104 into the wellbore 100. The fiber optic acquisition unit 122 includes a light source for producing optical signals that are transmitted into the fiber optic cable 120. Backscattered light is received by a detector in the fiber optic acquisition unit 122.

In some embodiments, the acoustic waves that impinge upon a fiber optic cable 120 in the area of the perforations 110 and the downhole equipment such as the downhole lift mechanism 146 may cause a characteristic of the fiber optic cable to change, which affects characteristics of backscattered light from the fiber optic cable portion in the area of the perforations 110. A portion of the fiber optic cable 120 in the proximity of the perforations 110 and or the downhole equipment such as the downhole lift mechanism 146 means that the portion of the fiber optic cable 120 is capable of detecting vibration noise associated with the flow to or from the perforations 110 and or vibration as a result of the operation of the downhole lift mechanism 146.

In some embodiments, a fiber optic acquisition unit 122 may be positioned at the earth surface 106 close to the wellbore 100. The fiber optic cable 120 extends from the fiber optic acquisition unit 122 through the hangar 126 into the wellbore 100. The fiber optic acquisition unit 122 includes a light source for producing optical signals that are transmitted into the fiber optic cable 120. Backscattered light is received by a detector in the fiber optic acquisition unit 122.

In some embodiments shown in FIG. 2, the signals detected by the detector of the fiber optic acquisition unit 122 are transformed into data that can be transmitted (at 124) to a remote analysis unit 126. The analysis unit 126 may be used to analyze the data corresponding to the detected signals to determine whether any problem is present in the wellbore 100. In some embodiments, the data may be acquired by the fiber optic acquisition unit 122 in real time, and the analysis unit 126 may analyze such data in real time in order to provide instantaneous (or nearly instantaneous) status updates of downhole conditions or conditions of a downhole component. In some embodiments, background noise may be initially detected (such as by monitoring backscattered signals from the fiber optic cable 120 before any downhole operation is started). This background noise can then be removed from subsequent data considered by the analysis unit 126 for more accurate processing.

In some embodiments, instead of using a remote analysis unit 126, the analysis unit 126 can be part of the fiber optic acquisition unit 122.

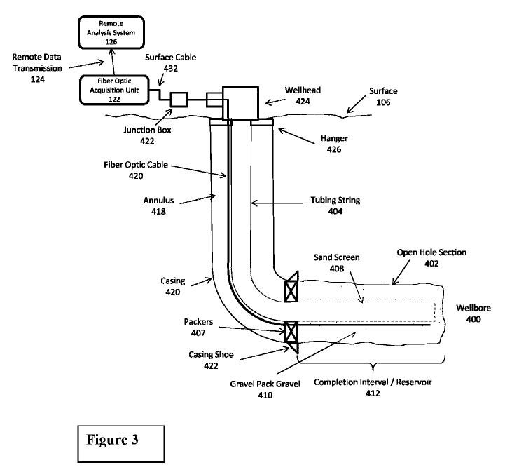

Referring generally to FIG. 3, an embodiment of system to monitor fluid flow in a wellbore 400, which is completed with a gravel pack is illustrated. In these embodiments, an exemplary arrangement of a well completed with a gravel pack in which downhole equipment is positioned in a wellbore 400 is illustrated in this diagram as a horizontal well.

Although the well depicted in FIG. 3 is illustrated as horizontal in the completed zone, the well may have any orientation or any angle.

FIG. 3 depicts a wellbore 400 completed with casing 420 down to a casing shoe 422. Below the casing shoe 422, the wellbore 400 is an openhole section 402.

Also in FIG. 3 the wellbore 400 is completed in the open hole section 402 which represents the completion interval/reservoir 412 from which the from which fluid is produced or into which it is injected.

In some embodiments, the downhole equipment includes a tubing string 404 which is connected to a sand screen 408. The sand screen 408 is positioned in an openhole section 402 of the wellbore 400 and surrounded by gravel pack gravel 410. The gravel pack gravel 410 is isolated between the walls of the wellbore 400, the packer 407 and kept outside the tuning string 404 by the sand screen 408.

The purpose of the gravel pack gravel 410 and the sand screen 408 is to stabilize the wellbore 400 in the vicinity of the openhole section 402 and to keep sand from the completion interval/reservoir 412 from entering the wellbore 400 during fluid production.

At the time of completion of the wellbore 400, the technique for placing the gravel pack gravel 410 behind the sand screen 408 is to pump the gravel through a controlled process which places the gravel pack gravel 410 into position between the wall of the wellbore 400, the packer 407 and kept outside the tuning string 404 by the sand screen 408.

During this completion phase, a fiber optic cable 420 may be run into the wellbore 400 along the outside of the tubing string 404 and the sand screen 408. During the time of pumping the gravel pack gravel 410 into place, the fiber optic cable 420 is subject to vibration resulting from the completion work. This will result in characteristic vibration which may indicate information regarding the gravel packing operations, for instance, the proper placement of gravel pack gravel.

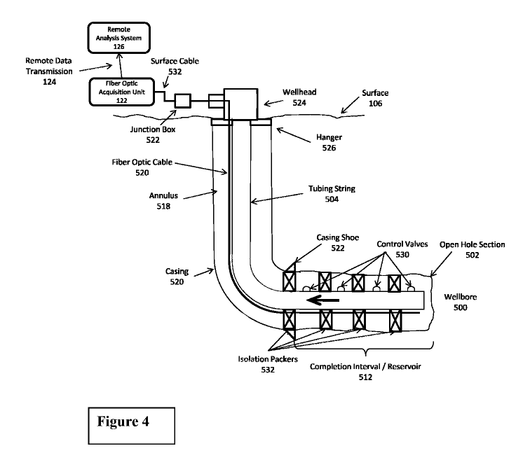

Referring generally to FIG. 4, an embodiment of system to monitor downhole equipment, in particular downhole control valves, is illustrated. In some embodiments, FIG. 4 illustrates an exemplary arrangement of another type of completion in which a wellbore 500 is completed with downhole control valves 530.

Although the well depicted in FIG. 4 is illustrated as horizontal in the completed interval 512, the well may have any orientation or any angle.

FIG. 4 depicts a wellbore 500 completed with casing 520 down to a casing shoe 522. Below the casing shoe 522, the wellbore 500 is an openhole section 502.

Although the well depicted in FIG. 4 is illustrated as an openhole section 502 in the completed interval 512, the wellbore 500 may have casing 520 set to the bottom of the well.

Also in FIG. 4 the wellbore 500 is completed in the open hole section 502 which represents the completion interval/reservoir 512 from which the from which fluid is produced or into which it is injected.

In some embodiments, the downhole equipment includes a tubing string 504 which is connected to one or more isolation packers 532. Between the isolation packers are one or more control valves 530 which can be adjusted ether electrically or hydraulically.

One purpose of the control valves 530 is to control the movement of produced or injected fluid or gas from or into the completed interval 512. Each control valve 530 is designed to control the fluid movement in the completed interval 512 in the zone in which it is placed between the isolation packers 532.

During the completion of the wellbore 500, a fiber optic cable 520 is run into the wellbore 500 along the outside of the tubing string 504 through the isolation packers 532 to the end of the tubing string 504.

During the time of operating the well, the fiber optic cable 520 is subject to vibration as a result of the operation/movement/changing of the operating position or condition of the downhole control valves 530. This operation/movement/changing causes a characteristic vibration that can be detected by the fiber optic cable 520. By monitoring the vibration information from the fiber optic cable 520, information may be determined as to the condition of the downhole control valve 530. For instance, information may be determined that will confirm that the downhole control valve 530 is moving, or has moved, and is operating as expected.

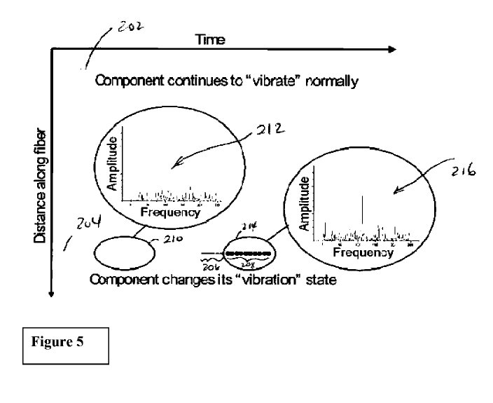

FIG. 5 shows an embodiment of an exemplary output that may be displayed by the analysis unit 126, such as on a computer monitor. FIG. 5 shows an example of a chart that plots indicators associated with different locations along the fiber optic cable (expressed as distance from the surface 106 along the fiber optic cable) over time. Line 202 (which is made up of a series of indicators) represents a first location along the fiber optic cable 120, while line 204 represents a second, different location along the fiber optic cable 120. The visual indicators provided along the line 202 indicate that a downhole component at the location corresponding to line 202 continues to vibrate normally over time.

However, the visual indicators along the line 204 indicate that over time, vibration has increased. Increasing vibration may be indicated by a first group of indicators 206, which indicates that vibration has increased and a second group of indicators 208, which indicates that vibration, has further increased. This increase may be indicative of a change in flow demonstrating fluid influx from the reservoir 112, 113, through the perforations 110. Additionally, the increase in vibrations may be indicating a change in production type such as an influx of solids or gas. Note that indicators 206 are smaller ovals, while indicators 208 are larger ovals. Different colors may be assigned to the different indicators 206 and 208.

In the region 210 of line 204 that is associated with “normal” vibration, a user may retrieve an associated chart 212 (such as by clicking on the region 210 with a user input device such as a mouse device) that plots noise amplitude with respect to frequency. In the region 214 of the line 204 associated with a high vibration condition, the user can retrieve another chart 216 (such as by clicking in the region 214) that plots noise amplitude with frequency. Note that the noise amplitudes in chart 216 have larger spikes than amplitudes depicted in chart 212.

In some embodiments, a spectral analysis may be performed by the analysis unit 126 on the waveforms depicted in charts 212 and 216 to determine flow rate at the location corresponding to line 204. Based on such spectral analysis, the user may be alerted that flowrate and/or fluid parameters may have changed at the location corresponding to line 204 is experiencing problems, and may need attention or yields information confirming a desired condition.

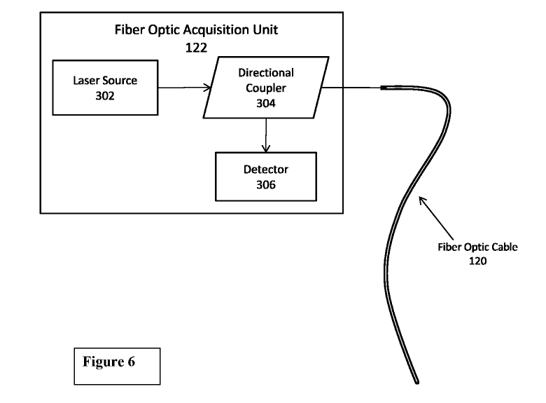

FIG. 6 shows an embodiment with exemplary components of the fiber optic acquisition 122, which includes a coherent light source 302 (e.g., laser source). Light generated by the coherent light source 302 is transmitted through an optical directional coupler 304 into the fiber optic cable 120. Coherent Rayleigh backscattered light is returned from different points along the fiber optic cable 120. The returned backscattered light is provided through the directional coupler 304 to an optical detector 306.

The position in which a particular part of the backscattered light signal originates may be determined from the round trip transit time from the fiber optic acquisition unit 122 to a location of interest and back.

Rayleigh scattering arises from inhomogeneities in the glass of the optical fiber which results from density or composition fluctuations on a length scale much smaller than an optical wavelength and that are frozen into the glass at the time the fiber is drawn. With incoherent probe pulses the energy from all the scattered light is summed at the detector. However, if the source is coherent (i.e. there is a predictable phase relationship between all parts of the light pulse), then the phase of the light re-radiated from each of the scatterers (points along the optical fiber) has a fixed, but random, relationship. As a result, when the light from all these scatters is combined at the detector 306, the signal generated by the detector 306 is sensitive to the relative phases of the light from each scatterer. In other words, the generated signal is based on the summation of the electric fields of each scatterer, which is a phasor. When these are added, the summation may be modeled as the sum of a large number of complex numbers and the summation can result in a very large signal (if the phase relationships are such that the phasors add in amplitude—i.e., there is a constructive inference). However, if the phases are such that amplitudes sum to near zero, then the resulting detected signal can be very weak. The detected signals as a function of distance along the optical fiber thus takes the appearance of a jagged waveform, which however, is fixed if the optical fiber is undisturbed (e.g., no vibration noise) and if the probe optical frequency is constant.

If the optical fiber is disturbed at a particular position, such as due to impinging waves or due to increased strain applied by some mechanical means on a portion of the optical fiber, then the phase relationship between the scatterers within one pulse width are perturbed and the backscatter signal is altered. This change in the backscatter signal can be detected and used to derive a measure of the acoustic perturbations suffered by the optical fiber at any particular location.

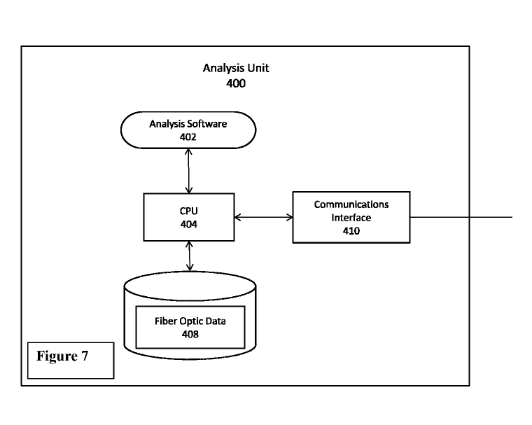

FIG. 7 shows a schematic representation of an embodiment with an exemplary analysis unit 400, which can be implemented with a computer, for example. The analysis unit 400 includes analysis software 402 that is executable on one or more central processing units (CPUs) 404. The CPU 404 is connected to storage 406. The storage 406 may contain backscattered optical data 408 received from the fiber optic acquisition unit 122 (as shown for example in FIG. 1).

The CPU 404 is connected to a communications interface 410, which in turn is connected to a communications link that is coupled to the fiber optic acquisition unit 122.

In some embodiments, instructions of the analysis software 402 are loaded for execution on a processor such as the one or more CPU 404. The processor may include microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the invention.

What is claimed is:

1. A method for use in a hydrocarbon production system:
providing a fiber optic sensor system deployed in a hydrocarbon production system, wherein the hydrocarbon production system comprises production components, productions fluids and solids which are located in either the wellbore or at a wellhead surface facility, and wherein the fiber optic system extends through the hydrocarbon production system to a location of interest;
providing at least one production component in the production system; wherein the fiber optic system is situated so as to detect vibration of the production component;
providing a signal acquisition and analysis unit, wherein the analysis unit is in communication with the fiber optic system;
sending light signals down the fiber optic sensor system; and
analyzing detected light signals with the analysis unit, wherein the analysis unit uses a distributed vibration sensing (DVS) analysis to identify a change in the production system flow condition based upon measured vibration of the production component.

2. The method of claim 1, wherein the fiber optic system comprises at least one single-component or multi-component (2C or 3C) vibration sensor system.

3. The method of claim 1, further comprising determining the cause of the production system flow condition change based upon the analyzed light signals received from the analysis unit.

4. The method of claim 3, wherein the production system flow condition change is caused by at least one member selected from: the introduction of fines or other solids into the wellbore; a change in the average size of fines or solids being introduced into the wellbore; a change in the production rate of the hydrocarbon being introduced into the wellbore; a change in the fluid flow regime of the well; a change in the injection profile during production, injection and or stimulation; and microseismic events resulting from flow or stimulation in the wellbore or in a nearby well.

5. The method of claim 3, wherein the production system flow condition change is caused by at least one member selected from: a change in the fluid conduit cross section; a change in operating condition or leak of a downhole gas lift valve; and a change in the fluid flow behind pipe.

6. The method of claim 3, wherein the production system flow condition change is caused by at least one member selected from: a change in the state of a gas production system; a gas breakthrough into the wellbore; and a change in the state of gas introduced into the flow conduit.

7. The method of claim 3, wherein the production system flow condition change is caused by at least one member selected from: a change in the liquid loading of the wellbore; a change in zonal production, including flow or no flow, a change in flow regime and possible identification thereof; a change in the cross flow between zones and another well; gas production or injection; and treatment agent injection.

8. The method of claim 3, wherein the production system flow condition change is caused by at least one member selected from: a change in the operating state of a passive or active Inflow Control Device (ICD) deployed in the wellbore; a change in the operating state of a passive or active Inflow Control Valve (ICV).

9. The method of claim 3, wherein the production system flow condition change is caused by at least one member selected from: a change in the downhole fluid flow regime; a change in the fluid emulsion condition of the downhole fluid; and a change in the fluid production rate of the reservoir or zone.

10. The method of claim 3, wherein the production system flow condition change is caused by a water breakthrough into the wellbore.

11. A method for use in a hydrocarbon production system:
providing a fiber optic sensor system deployed in a hydrocarbon production system, wherein the hydrocarbon production system comprises production components, productions fluids and solids which are located in either the wellbore or at a wellhead surface facility, and wherein the fiber optic system extends through the hydrocarbon production system to a location of interest;
providing at least one production component in the production system; wherein the fiber optic system is situated so as to detect vibration of the production component;
providing a signal acquisition and analysis unit, wherein the analysis unit is in communication with the fiber optic system;
sending light signals down the fiber optic sensor system; and
analyzing detected light signals with the analysis unit, wherein the analysis unit uses a distributed vibration sensing (DVS) analysis to identify to a change in integrity or operating condition of the production component based upon measured vibration of the production component.

12. The method of claim 11, wherein the fiber optic system comprises at least one single-component or multi-component (2C or 3C) vibration sensor system.

13. The method of claim 11, further comprising determining the cause of the production component operating condition or integrity change based upon the analyzed light signals received from the analysis unit.

14. The method of claim 13, wherein the production component change is caused by at least one member selected from: a change in the operational state of a gas lift valve; a leaking gas lift valve; and a leak of the production tubing or the casing; and flow or erosion behind the casing or the tubing.

15. The method of claim 13, wherein the production component change is caused by at least one member selected from: erosion caused by solids in produced fluid from the wellbore or injected fluid into the wellbore; erosion or corrosion resulting from cavitation; and a thermal expansion of the downhole component.

16. The method of claim 13, wherein the production component change is caused by at least one member selected from: friction based wear of a pump; rod wear from movement of a pump rod; a worn pump bearing; a decrease in pump performance; and the location or change of fluid level in the wellbore.

17. The method of claim 13, wherein the production component change is caused by at least one member selected from: a change in the operational state of a flow control valve, or an active ICD; and the plugging or reduction in flow through of a production or injection system component.

18. The method of claim 13, wherein the production component change is caused by at least one member selected from: a decrease in the operational capacity of a surface driven pump; and a decrease in the operational capacity of an ESP.

19. The method of claim 13, wherein the production component change is caused by flow back of proppant following a downhole treatment or stimulation operation.

20. The method of claim 13, wherein the production component change is caused by at least one member selected from: a placement of a downhole screen; and a placement of a downhole gravel pack.
